(19) United States
(12) Patent Application Publication
(10) Pub. No.: US 2024/0285117 A1
(43) Pub. Date: Aug. 29, 2024

(54) SENSOR FOR A COFFEE GRINDER

(71) Applicant: Hemro International AG, Zürich (CH)

(72) Inventor: Arnaldo RODRIGUES, Winterthur (CH)

(73) Assignee: Hemro International AG, Zürich (CH)

(21) Appl. No.: 18/573,691

(22) PCT Filed: Jun. 7, 2022
(86) PCT No.: PCT/EP2022/065431

§ 371 Date: Dec. 22, 2023

(30) Foreign Application Priority Data
Jun. 23, 2021 (EP) 21181224.3

(51) Int. Cl. A47J 31/52; A47J 31/44; A47J 42/40

(52) U.S. Cl. CPC A47J 31/521; A47J 31/4425; A47J 31/5253; A47J 42/40; A47J 2202/00

(57) ABSTRACT

Sensor unit for use in combination with a coffee brewing machine and a separate coffee bean grinder, wherein it is a unit separate from said coffee brewing machine and from the coffee bean grinder. It has a bottom part to be located below a coffee dispenser and in a brewed coffee dispensing area of the coffee brewing machine, one load cell for measuring the weight of a cup located on top as a function of time, at least one central processing unit collecting and at least temporarily storing the data received from said load cell and at least one wired or wireless communication for data exchange with the coffee bean grinder to transmit the data received from the load cell to said coffee bean grinder for controlling the grinding process.

### TECHNICAL FIELD

The present invention relates to a sensor unit to be used together with a separate coffee brewing machine and a separate coffee grinder. Furthermore it relates to users of such a sensor, and methods of operating such a sensor.

### PRIOR ART

The coffee brewing process starting out from coffee beans involves the steps of grinding the coffee beans and subsequently extracting the coffee from the ground coffee beans by feeding a preset amount of hot water into a corresponding brewing chamber.

There are different ways to structure this process. There are combined fully automatic machines, which need to be supplied with water and coffee beans, and in which the coffee is ground, automatically transported to the brewing chamber, and then automatically a preset amount of hot water is introduced into that chamber and the outflow in coffee is collected in a cup. The control in these machines is a delicate matter, since the aim is to provide a reliable and constant quality of coffee as possible, including additional features such as providing the right amount of foam on top of the coffee, being able to distinguish between espresso and other types of coffee, et cetera. Machines of this fully integrated type and corresponding controls are known e.g. from U.S. Pat. No. 4,767,632 or DE 3107549.

These combined fully automatic machines are hardly used in commercial high-end coffee brewing environments. In these environments there are generally separate coffee brewing machines and coffee bean grinders. The reasons are manifold, the so-called baristas want to have freedom to adapt parameters as concerns the grinding process and as concerns the brewing process, good grinding machines need a different environment, different materials, different manufacturing focuses, and different electronics than good coffee brewing machines, and having these two key elements in one single machine reduces flexibility as concerns replacement in case of damage et cetera.

There are like two different markets for these high-end machines, one market for the coffee brewing machines and one market for the coffee bean grinder machines. The coffee brewing machines are highly controlled machines having a variety of sensors and control mechanisms to make sure that water of the appropriate pressure and temperature, if need be according to a corresponding pressure and temperature profile, is supplied to the brewing chamber, typically in this field in the form of a porta filter. The porta filter (also sometimes spelled porta-filter or portafilter) is the component of the espresso maker that holds the ground espresso beans (coffee grounds) before and during the brewing process. It is including a handle, which allows the person who is brewing the espresso to hold the portafilter unit, on the one hand for inserting it in a corresponding opening of the coffee bean grinding machine and to fill it with ground coffee, and on the other hand to transfer it to the coffee brewing machine, attaching it to it, typically using a bayonet mechanism, and after the brewing process to remove it again and empty it tipping it over. Another part of the portafilter is the filter basket, which fits inside the exterior of the portafilter. It is normally made of metal and has small holes which act as a screen and allow the extracted espresso to run through, down towards the bottom and out a hole or chute into the cup sitting below. EP-A-3662794 discloses the possibility of using a flowmeter sniffer as a separate unit to be connected to the brewing machine, and the parameters determined by that flowmeter sniffer are used for controlling the grinder.

WO2014207281 and U.S. Pat. No. 4,767,632 disclose measuring the water flow in the brewing machine for brewing control purposes.

WO 2009/010190 generally discloses the control of the grinder as a function of parameters of the brewer or rather the brewing process.

EP-A-3162256 discloses the concept of using a load cell in a foot portion of the grinder to weigh the ground coffee in a grinder and to control the coffee brewer using the corresponding data of the load cell beneath the ground coffee receptacle.

WO 2012146641 and EP 3797654 disclose load cells integrated into the brewing machine. US-A-2018199752 discloses a brewing quality measuring device including an electronic scale, a thermometer, a position maintaining device and an operating/control unit. The electronic scale includes a platform used for placing a container having a brew therein. The thermometer has a measuring portion. The position maintaining device is used for holding the measuring portion of the thermometer at a measuring position. The operating/control unit is used for receiving measuring signals from each of the electronic scale and the thermometer. The measuring position corresponds to a specific position of the container when the container is placed on the platform, so that the thermometer measures the temperature of the brew at the measuring position.

EP-A-3797654 discloses a coffee dispensing system which comprises: a plurality of grinding machines that contain a different coffee bean mix, a coffee machine, a filter holder suitable for containing a dose of ground coffee and to be disposed in each grinding machine so as to be filled with ground coffee to form a desired dose of ground coffee and suitable to be placed in the coffee machine for infusing the ground coffee, a CPU operatively connected to the grinding machines and to the coffee machine, and a user interface operatively connected to the CPU; the user interface being configured in such a way to send input parameters selected by the user based on the desired coffee type to the CPU; wherein the CPU is configured in such a way to receive the input parameters sent by the user interface and calculate output parameters suitable for controlling the grinding machines and the coffee machine.

EP-A-3162256 discloses a coffee machine which comprises a weighing system to measure the weight of the liquid coffee extracted in a cup and a coffee grinding machine (comprising a weight system to measure the weight of the ground coffee dispensed in a filter-holder. The coffee machine comprises a control unit provided with a memory, wherein infusion ratios for different types of coffees are saved and the coffee grinding machine comprises a control unit operatively connected to the control unit of the coffee machine to send information about the weight of the ground coffee contained in the filter-holder. The control unit of the coffee machine uses the information received from the coffee grinding machine to extract a coffee that satisfies an infusion ratio selected by the operator.

US-A-2017295983 discloses a method and a system for managing a brewing process in which a solution is produced by mixing a solvent with a solute and a beverage is extracted from the solution. The system includes a temperature sensor device for sensing a temperature change per unit time of the solvent to create temperature information; a first measurement device for sensing a weight increase per unit time of the beverage to create first weight information while counting the time elapsed in the brewing process to create timing information; and a computing device comparing preset standard-state information with the temperature, first weight and timing information. A warning message is displayed on the computing device to remind a brewing operator to stop brewing the beverage when any of the temperature, first weight and timing information created at a specific unit time does not match the standard-state information of the same unit time.

### SUMMARY OF THE INVENTION

Coordination between the coffee bean grinder machine and the separate coffee brewing machine operation is carried out by the barista. However there is not always such an experienced person available, or some further automation and control is desired, and there is therefore a need for coordinating the operation of these two separate elements. Is therefore an object of the present invention to allow for coordination of the operation of a coffee bean grinder machine and a separate coffee brewing machine in an a simple as possible but at the same time as effective and reliable manner as possible and without interfering with the devices.

In particular, in view of the fact that typically the coffee brewing machines are equipped with their own controls and operation schemes, which shall not be influenced but also should not have to be adapted to implement a corresponding control, the aim is to provide a method for controlling the coffee bean grinder to adapt optimally to the corresponding operation of a coffee brewing machine.

According to a first aspect of the present invention there is therefore proposed a sensor unit for use in combination with a coffee brewing machine and a separate coffee bean grinder, wherein said sensor unit is a unit separate from said coffee brewing machine and separate from said coffee bean grinder, wherein said sensor unit comprises
a bottom part to be located below a coffee dispenser and in a brewed coffee dispensing area of said coffee brewing machine,
at least one load cell for measuring the weight of a cup located on top of said bottom part for filling with coffee with said coffee dispenser as a function of time,
at least one central processing unit collecting and at least temporarily storing the data (typically an “extraction profile” i.e. the curve profile of weight vs time and temperature vs time, preferably including the time between first and last drop) received from said load cell and comprising at least one wired or wireless communication for data exchange with said coffee bean grinder to transmit the data received from said load cell to said coffee bean grinder for controlling the grinding process of said coffee bean grinder.

The need for connectivity between coffee machine and grinder is becoming an increasingly higher market demand. A coffee machine will contain key information such as flow of water into a coffee cup, temperature, and extraction time, along with other useful details. These parameters are useful to the barista who then sets the grinder disc distance and further variables of the coffee grinder which lead to a different output e.g. grind time, or ground weight, grind speed, and other, to change the consistency (coarseness) of the coffee until the right taste is achieved in the coffee cup. This entire process can be automated if the information between grinder and coffee machine is shared via a connectivity protocol, and when said information is used with an intelligent algorithm that optimizes extraction and grind size.

The idea here is to have a separate sensor unit that can be laid on any coffee machine between cup and base of the coffee machine (e.g. on the base of the coffee machine, although other external fixation means are possible). Therefore no intrusive installment is required. The sensor unit tracks the weight and if desired temperature of coffee that is poured into the cup along the pouring period, typically as a function of time, and transmits this information to the grinder which adjusts the grind size (electrically) and further variables of the coffee grinder which lead to a different output e.g. grind time, or ground weight, grind speed, and other as needed, such that the loop reaches the required extraction.

The greatest advantage of this solution is that there is no need to get signals directly from the coffee machine. Currently, to get extraction parameters there is need to have a tight integration with the specific coffee machine. For installed-base, this means intrusion of the entire coffee machine population. A solution that is independent from coffee machine is truly versatile with little intrusion and customization.

What is unique is that this separate sensor unit communicates information to the grinder, but what is even more unique, is that is not actually communicating information from the coffee machine, but rather, it is communicating information from the cup to the grinder. Essentially this separate sensor unit is useable under any recipient, whether it is an espresso machine, filter coffee machine, or any recipient receiving a weight. It records grammage, time, and temperature, whereas e.g. EP3662794A1 records information from the flowmeter that is installed in the coffee machine so hence requires an integrated solution, whereas this is a fully flexible solution.

in the present context when talking about a cup this would include any kind of receptacle commonly used for receiving coffee, so it includes espresso cups, coffee cups, but also glasses for latte macchiato and the like.

Approximate dimensions of the device are typically as follows: width: 110-120 mm (for one single cup, if several cops are to be located next to each other, this typically multiplies with the number of cups), length: 110-120 mm, height (less than or in the range of) 20-40 mm, and height with optional thermal camera (160 mm max). The design would eventually be executed such that it allows both mat and cup beneath a group head of a coffee machine. The weight cell specification can be as follows: maximum weight capacity typically: 500 g to 1000 g, minimum weight capacity: typically 0.1 g accuracy is sufficient.

A thermal camera is an optional feature.

The weight can be tarred to zero g whenever a cup is set on top of the sensor unit. This can be achieved by the touch of a button, or alternatively with a switch which tars to zero as soon as the first drop hits the cup

The sensor unit can be adapted for one single cup, it may however also be adapted for putting two caps next to each other, for example in case of a porta filter having two outlets.

In that case, there can be one single load cell in the corresponding housing, or individual load cells for each of the cups. Typically there is only one central processing unit in that case even if there are several places for the cups.

According to a preferred embodiment, the sensor unit further comprises at least one further sensor for directly or indirectly, preferably directly, measuring the temperature of the coffee dispensed into said cup or being located in said cup, preferably as a function of time. Preferably said further sensor is an optical thermo-sensor.

The data obtained from said further sensor is transmitted to said central processing unit, where it is collected and at least temporarily stored, and is transmitted to the coffee bean grinder at the same time or before or after transmission of the data received from said load cell concomitantly.

The further sensor is preferably mounted on or in a sensor arm protruding vertically above said top and preferably in a height suitable and adapted to measure the temperature of the coffee entering into said cup or being located in said cup, preferably optically.

The further sensor can preferably be mounted at a height of at least 50 mm, preferably at least 75 mm, preferably in the range of 75-160 mm or in the range of 80-120 mm above said top, and further preferably is pointing with its optical axis obliquely downward into the interior of a cup to be located on said top.

The sensor arm is preferably located behind said cup, preferably close to or adjacent to a back wall of the brewed coffee dispensing area of the coffee brewing machine.

The bottom part can have a vertical height in the range of 2-40 mm, preferably in the range of 5-20 mm, more preferably in the range of 7-15 mm,
and/or the bottom part can have a horizontal length and/or width in the range of 50-140 mm, preferably in the range of 80-120 mm,
and/or the height of the sensor arm above the top can be in the range of 75-160 mm, preferably in the range of 80-120 mm.

The bottom part typically comprises a housing, preferably made of a thermoplastic material, with a bottom surface and a top surface for positioning the cup, and wherein said housing comprises the load cell, the central processing unit and a power supply, in the form of a battery and/or of a wired power supply, and wherein it is preferably suitable to be put onto a base of said coffee brewing machine without modification thereof or of the coffee brewing machine in general.

The separate sensor may further comprise input and output devices, in particular a display, to indicate the status, to visualize the measurements, to indicate the power level if supply is by a rechargeable battery, to indicate the connectivity of a wireless connection to the grinder, et cetera. Also it may contain an input device, or it may contain, replacing separate input/output devices of the sensor unit, means to communicate further with a mobile device (mobile phone) for individual sensor settings using the input output possibilities of the mobile device via correspondingly adapted app. To this end a Bluetooth or wireless LAN connectivity can be provided, i.e. the separate sensor can be integrated into the local wireless LAN system connected to the Internet so that it can be controlled and/or monitored by using the corresponding app essentially independent of the location using that app.

Preferably the sensor comprises means to tar the weight measurement by the load cell at the moment when a cup is put on the top, wherein said tarring can be initiated manually by a corresponding button to be operated or by way of an electrical or electronic control, which preferably can be initiated when the weight cell detects a first drop of coffee hitting the cup. The central processing unit preferably transmits the data to the coffee bean grinder by way of wireless communication to a grinder control unit, preferably by way of one of the standards selected from: Bluetooth, BLE, ZigBee, Z-wave, 6LoWPAN, Thread, LoRaWAN, 2G, 3G, 4G, 5G, LTE, NFC.

The central processing unit normally transmits the data received from said load cell as a function of time including the rate of change as a function of time.

Furthermore the present invention relates to the use of a sensor unit as described above as a separate unit together with a coffee brewing machine and a separate coffee bean grinder. According to this use, the sensor unit as described above, as a separate unit, is shifted into a coffee dispensing area of a pre-existing coffee brewing machine essentially without modification thereof, is connected with the coffee bean grinder for data exchange, and at least one of or a combination of the following: the grinding time, the grinding degree, the amount of ground coffee, of the coffee bean grinder is adapted as a function of the data provided by the separate sensor unit to the coffee bean grinder, preferably without further data exchange between the coffee bean grinder and the coffee brewing machine next to the sensor unit. The proposed use is therefore like an upgrading process without involving direct hardware interference with an existing coffee brewing machine and with an existing coffee bean grinder. Many existing coffee bean grinder is and coffee brewing machines provide for interfaces for data exchange and control. So the proposed use and the proposed separate unit can be used astonishingly easily in such a context, because all that needs to be done to improve the quality of the coffee is to add the separate unit and to link it to the interfaces of the coffee bean grinder and the coffee brewing machine and to integrate the corresponding data of the separate unit into the control process for the grinder.

In addition, the present invention relates to a method of operating a coffee brewing machine, a separate coffee bean grinder and a separate sensor unit as described above, wherein the separate sensor unit is shifted into the pre-existing brewed coffee dispensing area of the coffee brewing machine essentially without modification thereof, is connected with the coffee bean grinder for data exchange, and wherein the grinding time and/or the grinding degree and/or the amount of ground coffee of the coffee bean grinder is adapted as a function of the data provided by the separate sensor unit to the coffee bean grinder without further data exchange between the coffee bean grinder and the coffee brewing machine. The coffee bean grinder typically comprises at least one grinder module, at least one coffee bean container, at least one grinder control unit equipped with data exchange means with the separate sensor unit, and preferably and preferably a load cell for measuring the weight of the ground coffee into a porta filter located in a ground coffee dispensing area of the coffee bean grinder.

The coffee brewing machine typically comprises at least one water tank, at least one water pump, at least one water flow through heater, as well as an interface to a porta filter and below a porta filter brewed coffee dispensing area for locating a cup to be filled with liquid coffee during the brewing process.

Last but not least the present invention relates to a kit of parts comprising a sensor unit as described above, a separate coffee bean grinder as well as a separate coffee brewing machine.

Further embodiments of the invention are laid down in the dependent claims.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows a schematic illustration of a coffee brewing machine and a separate coffee bean grinding machine and the communication and control as proposed in this application;

FIG. 2 shows schematically a sensor unit according to the present invention.

### DESCRIPTION OF PREFERRED EMBODIMENTS

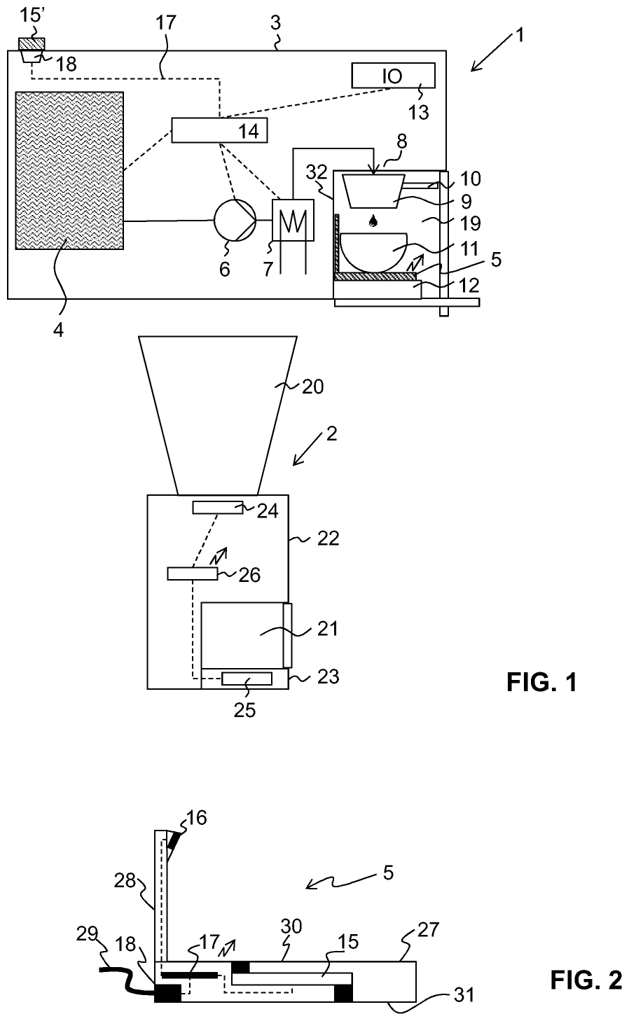

FIG. 1 shows the coffee brewing machine 1 and the separate coffee bean grinder 2 being two physically separate machine entities. The coffee brewing machine 1 comprises, in a housing 3, a water tank 4, a pump 6, a water flow-through heater 7, and an interface to a porta filter, which typically is in the form of an attachment by way of a bayonet mechanism. As illustrated by solid lines, there is water flow between the water tank 4 to the pump 6 and is then passed through the heater 7. The heater is attached to a corresponding power supply (not illustrated) and heats the water to the desired temperature. Additional valves (not illustrated) are provided to make sure not only the desired temperature but also the desired pressure are reached. Downstream of the water heater 7 the line carries on to the interface 8.

The coffee brewing machine 1 comprises a brewed coffee dispensing area 19, which is typically like a cutout or a recessed portion in the housing 3. That housing can be used to insert the porta filter 9, by holding it on the handle 10, and attaching it to the corresponding interface 8 firmly. Furthermore there is provided a user input/output device 13. Once the porta filter is inserted into the area 19 and attached to the interface 8 the user can start the desired brewing process by interacting with the interface 13. Coffee is then brewed and is flowing into the coffee cup 11, which is located on a corresponding base 12 of the machine 1.

Control in the coffee brewing machine 1 takes place way of a corresponding brewer control unit 14. Data transmission lines are indicated by dashed lines. The control unit 14 is normally provided with a data line to a sensor sensing the level of the water in the water container 4. Also it has a data line to the pump to control its speed and/or duration of operation. Furthermore there is a data and control line to the heater 8 to adapt and control the heating process. As indicated above, there are typically in addition to the illustrated elements valves and further sensor elements, these are also controlled or used for control by the control unit 14.

The coffee bean grinder 2 also has a separate housing 22. Usually on top of that housing there is provided a coffee bean container 20, which can be opened on the top to be refilled with coffee beans. At the bottom end of that coffee bean container 20, which is typically converging towards the bottom, there is provided the actual grinding mechanism or the grinder module 24, i.e. the actual grinding elements, typically one ring-like stationary and one cone like rotating grinder element, the rotating grinder element being driven by a motor.

There is furthermore provided an automatic adjustment mechanism to adjust the rotary speed of the motor, if need be the torque of the motor, and the width of the slot between the two grinder elements to adjust the resulting grain size. Control in that coffee bean grinder 2 is coordinated and carried out by a grinder control unit 26. The corresponding data lines are illustrated by dashed lines. Also the grinder typically comprises an input/output device for the user (not illustrated) which communicates with the grinder control unit 26 or which is integral with the grinder control unit. Furthermore the coffee bean grinder 2, in a separate foot portion 23, may comprise a load cell 25 for measuring the weight of the coffee which has been dispensed to a porta filter inserted into the ground coffee dispensing area and put onto a corresponding holder cooperating with the foot portion/load cell. Also this load cell 25 is in data connection with the grinder control unit 26, the grinder control unit 26 receiving information about the effective weight of the ground coffee filled into the porta filter. According to a first aspect of the invention there is provided a separate sensor unit 5, which is simply put on top of the base 12, and which itself then forms the standing platform for the cup 11. The separate sensor unit 5 therefore is located between the cup 11 and the base 12 of the coffee machine. The coffee machine does not have to be adapted in any way, all that needs to be done to install the separate sensor unit 5 is to shifted into the brewed coffee dispensing area 19, and, if needed, to attach it to a power supply. That attachment can be an independent power supply attachment, it may however also be attached to the power supply of the coffee machine directly or indirectly.

As illustrated in FIG. 2, that sensor unit comprises a bottom part 27 which is the bottom housing, and in that housing there is provided a load cell 15 which measures the weight of an object put on top onto the cup surface 30. The sensor unit is put with its bottom surface 31 on the top surface of the base 12.

In addition to that the sensor unit 5 comprises a central processing unit 17, which is connected to the output of the load cell and to a power supply 18, which, in this case, is connected with a power supply line 29. The supply can based on a re-chargeable battery concept, whereby the sensor unit can be charged overnight for use on next day. The user may also opt to switch off the sensor unit to resort to manual operation of the grinder if said grinder is enabled for both modes (adjustment of grind settings through connectivity, or adjustment of the same directly by the user).

The sensor unit 5 in addition comprises an upright sensor arm 28, on top of which there is located in optical thermal sensor 16. Also that sensor 16 is connected with the central processing unit 17 (connections indicated with dashed lines). Furthermore the central processing unit is provided with a wireless communication module (schematically illustrated by the arrow) for data communication with the grinder, for example Bluetooth or more specifically, to the grinder control unit 26, which itself is provided with means for wireless communication with the sensor unit 5.

The grinder is thus enabled to continuously monitor and calculate the status of the coffee machine and to control the needed parameters (i.e. fineness of ground coffee and/or the amount of ground coffee) for a constant brewing process only on the basis of some few presets and the incoming data from the sensor unit. The presets are mainly related to the desired extraction time and its upper or lower allowed deviation where a correction controlled by the grinder should start, the desired amount of water for the chosen recipe by the coffee machine and its thresholds for adjustment and/or the desired flowrate profile. In addition, these presets can be allocated to a memory structure, e.g. a recipe, to switch in a very simple way between different brewing processes resulting from another drink brewed by the coffee machine. Switching between different presets can be done in a manual way by the user on the grinder itself or in an automatic way by the coffee machine without user intervention by sending additional information about the status of the current recipe (or a change of recipe) to the grinder.

The true information content of the data provided by the sensor unit depends on the type of the load cell and/or thermal sensor.

Between the detected starting point and end point of the brewing process the grinder can easily determine the brewing process parameters, e.g. used amount of coffee in this shot, the extraction time and also the flowrate profile and the temperature.

Having calculated one or more of these brewing process parameters the grinder can adjust in an autonomous way with no additional information coming from the coffee machine the grinding discs adjustment (i.e. the distance between the rotating and fixed blade) and/or the amount of ground coffee e.g. by corresponding timing of the grinding, if need be further controlled by weight cell of the grinder and further variables of the coffee grinder which lead to a different output e.g. grind time, grind speed, etc. . . .

In the simplest case the grinder only adjusts the grinding blades space on the basis of one brewing process parameter, e.g. the extraction time: If the pre-defined “ideal” extrac¬tion time given to the grinder (e.g. 25 seconds) falls below a pre-defined value (e.g. 24 seconds) or threshold (in this case one second) resulting from analysis of the ticks of the last shot the grinder will auto¬ma¬tically increase the grinding fineness of the ground coffee by reducing the space between the grinding blades or grinding discs and vice versa. In this embodiment it is important that the grinder constantly grinds the same amount of coffee which is controlled either by time, by weight or a combination of time and weight.

But is also possible to analyze only the amount of coffee generated for each shot: If the pre-defined “ideal” coffee amount given to the grinder (e.g. 10 g is exceeded by an pre-defined value (e.g. 12 g) resulting from analysis of the integral of the ticks of the last shot the grinder will auto¬ma¬tically increase the coarseness of the ground coffee by increasing the space between the grinding blades or grinding discs and vice versa.

It is also possible to graphically analyse the extraction profile (i.e. weight of coffee brew that is extracted over time) and to define an upper and lower limit along the entire curve.

In another aspect of the invention the space between the grinding blades (or the grinding discs) is kept constant: If the extraction time is exceeded the amount of ground coffee is decreased and vice versa.

In a further embodiment the coarseness of the ground coffee, as well as its dosage (weight) are controlled by the grinder: In this case at least two brewing process parameters are necessary. For example, the extraction time, as well as if needed also the amount of coffee, are the analyzed data for each shot: If the amount of coffee and the extraction time are both too high the amount of ground coffee has to be increased and the coarseness of the ground coffee has also to be increased. If in another case the extraction time is too high and the amount of water is to low, the amount of ground coffee has to be decreased and the coarseness of the ground coffee has to be increased.

The great advantage of all embodiments of this invention is that the barista has only to focus on the grinder and not on the coffee machine: In daily business the barista's main recipe is a double espresso: He defines once in the permanent memory of the grinder the ideal extraction time, the ideal amount of used water and/or the ideal flowrate profile and the parameters to control (i.e. the grinding blades distance and/or the amount of ground coffee) for the perfect taste in his double espresso cups by using an App or the GUI of the grinder. The rest is done by the grinder autonomously.

In another case, especially if this complex brewing process has to performed by a non-well-trained user, the coffee machine sends additional information to the grinder to take control over the recipe (i.e. presets and grinding parameters) but not over the grinder. In this case the sensor unit sends to the grinder all parameters needed for controlling the brewing process by the grinder, e.g. ideal extraction time, the ideal amount of coffee and/or the ideal extraction profile (g/s) and the parameters to control but not the grinding discs adjustment. If a wireless transmission between sensor unit and grinder is prefer¬red the sensor unit as well as the coffee machine could use two separate senders, the grinder can have only one receiver if the protocol is e.g. Bluetooth.

According to an alternative realization, the coffee brewing machine can be provided with a dedicated interface to attach a corresponding sensor unit. The interface can be provided by way of a data line in the housing 3.

LIST OF REFERENCE SIGNS

| | |
|---|---|
| 1 | coffee brewing machine |
| 2 | coffee bean grinder |
| 3 | housing of 1 |
| 4 | water tank |
| 5 | separate sensor unit |
| 6 | water pump |
| 7 | water flow-through heater |
| 8 | interface to porta filter |
| 9 | porta filter |
| 10 | handle of 9 |
| 11 | cup |
| 12 | base for cup |
| 13 | user input output device |
| 14 | brewer control unit |
| 15 | load cell of 5 |
| 16 | thermo sensor of 5 |
| 17 | CPU of 5 |
| 18 | power supply of 5 |
| 19 | brewed coffee dispensing area |
| 20 | coffee bean container |
| 21 | ground coffee dispensing area |
| 22 | housing of 2 |
| 23 | separate foot portion of 2 |
| 24 | grinder module |
| 25 | load cell of 2 |
| 26 | grinder control unit |
| 27 | bottom part/housing of 5 |
| 28 | sensor arm of 5 |
| 29 | power supply line |
| 30 | cup surface of 5 |
| 31 | bottom surface of 27 solid lines water piping |
| 32 | back wall of 19 dashed lines data/signal lines |

1. A sensor unit for use in combination with a coffee brewing machine and a separate coffee bean grinder,
wherein said sensor unit is a unit separate from said coffee brewing machine and separate from said coffee bean grinder,
wherein said sensor unit comprises
a bottom part to be located below a coffee dispenser and in a brewed coffee dispensing area of said coffee brewing machine,
at least one load cell for measuring the weight of a cup located on top of said bottom part for filling with coffee with said coffee dispenser as a function of time,
at least one central processing unit collecting and at least temporarily storing the data received from said load cell and comprising at least one wired or wireless communication for data exchange with said coffee bean grinder to transmit the data received from said load cell to said coffee bean grinder for controlling the grinding process of said coffee bean grinder.

2. The sensor unit according to claim 1, wherein it further comprises at least one further sensor for directly or indirectly measuring the temperature of the coffee dispensed into said cup or being located in said cup, and wherein the data obtained from said further sensor is transmitted to said central processing unit, where it is collected and at least temporarily stored, and is transmitted to the coffee bean grinder at the same time or before or after transmission of the data received from said load cell concomitantly.

3. The sensor unit according to claim 2, wherein the further sensor is mounted on or in a sensor arm protruding vertically above said top and in a height suitable and adapted to measure the temperature of the coffee entering into said cup or being located in said cup.

4. The sensor unit according to claim 2, wherein the further sensor is mounted at a height of at least 50 mm above said top.

5. The sensor unit according to claim 2, wherein the sensor arm is located behind said cup.

6. Sensor unit according to claim 1, wherein the bottom part has a vertical height in the range of 2-40 mm,
or wherein the bottom part has a horizontal length and/or width in the range of 50-140 mm,
or wherein the height of the sensor arm above the top is in the range of 75-160 mm.

7. The sensor unit according to claim 1, wherein the bottom part comprises a housing, with a bottom surface and a top surface for positioning the cup, and wherein said housing comprises the load cell, the central processing unit and a power supply, in the form of a battery and/or of a wired power supply.

8. The sensor unit according to claim 1, wherein it comprises means to tar the weight measurement by the load cell at the moment when a cup is put on the top, wherein said tarring can be initiated manually by a corresponding button to be operated or by way of an electrical or electronic control.

9. The sensor unit according to claim 1, wherein the central processing unit transmits the data to the coffee bean grinder by way of wireless communication to a grinder control unit.

10. The sensor unit according to claim 1, wherein the central processing unit transmits the data received from said load cell as a function of time including the rate of change as a function of time.

11. A method of using a sensor unit according to claim 1 as a separate unit together with a coffee brewing machine and a separate coffee bean grinder.

12. The method of operating a coffee brewing machine, a separate coffee bean grinder and a separate sensor unit according to claim 1, wherein the separate sensor unit is shifted into the pre-existing brewed coffee dispensing area of the coffee brewing machine essentially without modification thereof, is connected with the coffee bean grinder for data exchange, and wherein the grinding time and/or the grinding degree and/or the amount of ground coffee of the coffee bean grinder is adapted as a function of the data provided by the separate sensor unit to the coffee bean grinder without further data exchange between the coffee bean grinder and the coffee brewing machine.

13. The method according to claim 12, wherein the coffee bean grinder comprises at least one grinder module, at least one coffee bean container, at least one grinder control unit equipped with data exchange means with the separate sensor unit.

14. The method according to claim 12, wherein the coffee brewing machine comprises at least one water tank, at least one water pump, at least one water flow through heater, as well as an interface to a porta filter and below a porta filter brewed coffee dispensing area for locating a cup to be filled with liquid coffee during the brewing process.

15. A kit of parts comprising a sensor unit according to claim 1, a separate coffee bean grinder as well as a separate coffee brewing machine.

16. The sensor unit according to claim 1, wherein it further comprises at least one further sensor for directly or indirectly measuring the temperature of the coffee dispensed into said cup or being located in said cup, as a function of time, wherein said further sensor is an optical thermo-sensor, and wherein the data obtained from said further sensor is transmitted to said central processing unit, where it is collected and at least temporarily stored, and is transmitted to the coffee bean grinder at the same time or before or after transmission of the data received from said load cell concomitantly.

17. The sensor unit according to claim 2, wherein the further sensor is mounted on or in a sensor arm protruding vertically above said top and in a height suitable and adapted to optically measure the temperature of the coffee entering into said cup or being located in said cup.

18. The sensor unit according to claim 2, wherein the further sensor is mounted at a in the range of 80-120 mm above said top, and is pointing with an optical axis obliquely downward into the interior of a cup to be located on said top.

19. The sensor unit according to claim 2, wherein the sensor arm is located behind said cup, close to or adjacent to a back wall of the brewed coffee dispensing area of the coffee brewing machine.

20. The sensor unit according to claim 1, wherein the bottom part has a vertical height in the range of 7-15 mm,
and/or wherein the bottom part has a horizontal length and/or width in the range of 80-120 mm,
and/or wherein the height of the sensor arm above the top is in the range of 80-120 mm.

21. The sensor unit according to claim 1, wherein the bottom part comprises a housing, made of a thermoplastic material, with a bottom surface and a top surface for positioning the cup, and wherein said housing comprises the load cell, the central processing unit and a power supply, in the form of a battery and/or of a wired power supply, and wherein it is suitable to be put onto a base of said coffee brewing machine without modification thereof or of the coffee brewing machine in general.

22. The sensor unit according to claim 1, wherein it comprises means to tar the weight measurement by the load cell at the moment when a cup is put on the top, wherein said tarring can be initiated manually by a corresponding button to be operated or by way of an electrical or electronic control, which can be initiated when the weight cell detects a first drop of coffee hitting the cup.

23. The sensor unit according to claim 1, wherein the central processing unit transmits the data to the coffee bean grinder by way of wireless communication to a grinder control unit, by way of one of the standards selected from: Bluetooth, BLE, ZigBee, Z-wave, 6LoWPAN, Thread, LoRaWAN, 2G, 3G, 4G, 5G, LTE, NFC.

24. The method according to claim 12, wherein the coffee bean grinder comprises at least one grinder module, at least one coffee bean container, at least one grinder control unit equipped with data exchange means with the separate sensor unit, and a load cell for measuring the weight of the ground coffee into a porta filter located in a ground coffee dispensing area of the coffee bean grinder.
